(19) United States
(12) Patent Application Publication
(10) Pub. No.: US 2006/0057322 A1
(43) Pub. Date: Mar. 16, 2006

(54) Sheeted roll and methods and apparatus for sheeting a roll

(75) Inventors: Charles Jonathan Kennett, Bridge Of Weir (GB); Sheila Hamilton, Kilmacolm (GB)

Correspondence Address: David S Resnick;Nixon Peabody, 100 Summer Street, Boston, MA, 02110, US

(73) Assignee: Teknek Electronics Limited, Renfrewshire (GB)

(21) Appl. No.: 10/512,626

(22) PCT Filed: Apr. 28, 2003
(86) PCT No.: PCT/GB03/01788

§ 371 Date: Apr. 4, 2005

(30) Foreign Application Priority Data
Apr. 26, 2002 (GB) 0209566.9
May 3, 2002 (GB) 0210162.4
Mar. 7, 2003 (GB) 0305232.1

(51) Int. Cl. B32B 33/00

(52) U.S. Cl. 428/40.1; 156/510

(57) ABSTRACT

The invention relates to a sheeted roll (100), an apparatus (300) for sheeting such a roll (100) and a method for sheeting a roll. According to the invention, the sheeted roll (100) comprises a roll core (110) having at least one sheet of material removably attachable thereon and subsequent sheets of material then being removably attachable on previous sheets of material on the roll core (110), said at least one sheet and subsequent sheets of material providing an adhesive surface holding the sheets to one another on said roll core (110). The sheeted rolls according to the invention are used, in particular, for cleaning surfaces or for dispensing photosensitive emulsions onto a circuit board.

This invention relates to a sheeted roll, and in particular, but not exclusively, to a sheeted roll having individual lengths of material located around its outer circumference. The material may be an adhesive cleaning material which can be used to remove impurities, or alternatively, the material may be a laminate or other adhesive material that requires to be dispensed. In addition, this invention relates to methods and apparatus for sheeting a roll, and in particular, but not exclusively, to methods and apparatus for sheeting a roll for use in removing impurities from a cleaning surface, the cleaning surface having first removed impurities from a surface of a workpiece.

Conventionally, apparatus for cleaning surfaces of a workpiece comprise at least one cleaning roll which is adapted to remove impurities from the workpiece.

The cleaning roll makes contact at a point with a surface of the workpiece removing any impurities thereon as the said workpiece is conveyed past the rotatably mounted cleaning roll.

Over a period of time, the cleaning roll will become contaminated with the impurities from the workpiece.

Conventionally, an adhesive roll with a continuous length of adhesive material is located adjacent to the cleaning roll. The adhesive roll makes contact at a point on the surface of the cleaning roll and in so doing, removes the impurities from the cleaning roll onto a portion of the continuous adhesive material located on the adhesive roll.

Subsequently, the said portion of the continuous adhesive material will require to be removed and replaced due to a build up of the impurities. This is normally done by a user cutting away the outer circumference of the used portion of the continuous adhesive material, leaving behind a new portion of continuous adhesive material for use.

Cutting of the used portion of the continuous adhesive material is done with the aid of a blade or knife. There is therefore a safety aspect to be considered to a user when cutting the said used portion of continuous adhesive material.

Furthermore, the cutting of the used portion of the continuous adhesive material can leave behind rough edges or fibres on the new portion of continuous adhesive material. This adversely affects the application of the new portion of continuous adhesive material onto the cleaning roll, resulting in impurities not being adequately removed or can cause contamination of the surrounding environment.

Conventional rolls of adhesive tape also have the disadvantage that they are in one continuous roll which makes cutting and obtaining specific lengths of adhesive tape difficult. There is also a safety aspect involved in using a blade or scissors to cut the continuous tape.

According to a first aspect of the present invention there is provided a sheeted roll comprising a roll core having at least one sheet of material removably attachable thereon and subsequent sheets of material then being removably attachable on previous sheets of material on the roll core, said at least one sheet and subsequent sheets of material providing an adhesive surface holding the sheets to one another on said roll core.

Preferably, the material is an adhesive which permits to remove impurities.

The material may be an adhesive material that requires to be dispensed.

The material may be coated with a release coating which facilitates removal of each sheet.

For example, the material may be a dry-film photopolymer laminate that is dispensed from the sheeted roll and applied to the surface of a workpiece and the laminate is a Mylar® backing film having an acrylic photosensitive emulsion for imaging of a circuit board.

According to a second aspect of the present invention there is provided an apparatus for sheeting a roll comprising a roll core having at least one sheet of material removably attachable thereon and subsequent sheets of material then being removably attachable on previous sheets of material on the roll core, said at least one sheet and subsequent sheets of material providing an adhesive surface holding the sheets to one another on said roll core, said apparatus comprising means for feeding material to be cut and a cutting roller having cutting means, the material being cut by said cutting means located within the cutting roller to form individually cut sheets.

Preferably the cutting means is rotatably coupled to the cutting roller.

Preferably the cut sheets are applied to a sheeting roller.

Preferably the cut sheets comprise an adhesive cleaning surface to remove impurities; the adhesive surface also facilitating the removable attachment of cut sheets onto one another when located on the sheeting roller.

According to a third aspect of the present invention, there is provided a method for sheeting a roll, said roll comprising a roll core having at least one sheet of material removably attachable thereon and subsequent sheets of material then being removably attachable on previous sheets of material on the roll core, said at least one sheet and subsequent sheets of material providing an adhesive surface holding the sheets to one another on said roll core, said method comprising:
providing a length of material to be cut; and
transferring said material to a cutting roller having cutting means to cut said material into cut sheets.

Preferably the cutting means is rotatably coupled to the cutting roller.

The adhesive may be self-adhesive material having a pressure-sensitive adhesive thereon.

The sheets may be rolled successively around the cylindrical core adhesive side out or adhesive side in.

The cutting means may suitably comprise a cutting cylinder. The cutting cylinder is preferably provided with a knife which traverses across its surface. Preferably, the adhesive contacts the cutting cylinder, the surface of which has a non-stick coating.

Embodiments of the present invention will now be described, by way of example only, with reference to the accompanying drawings in which:-

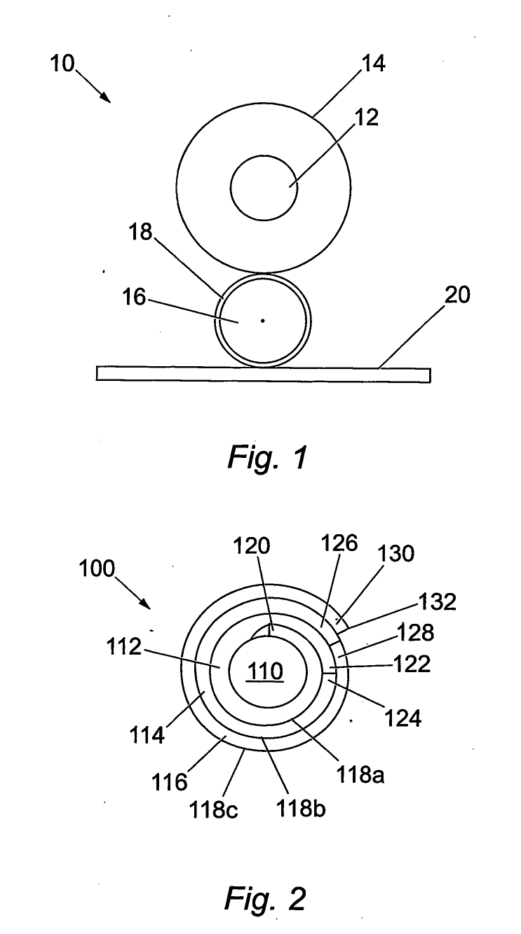

FIG. 1 is a side view of conventional apparatus for cleaning a workpiece;

FIG. 2 is a view from one end of an adhesive roll illustrating how sheets of material are superimposed onto a roll core made in accordance with the present invention;

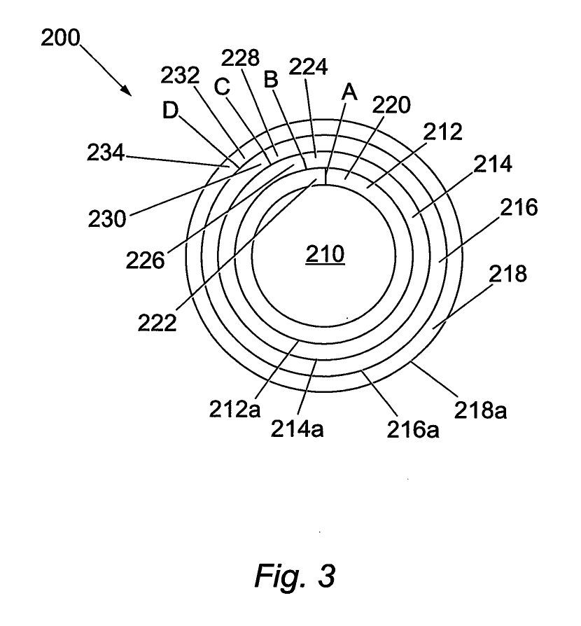

FIG. 3 is a view from one end illustrating an alternative to how sheets of material are superimposed onto a roll;

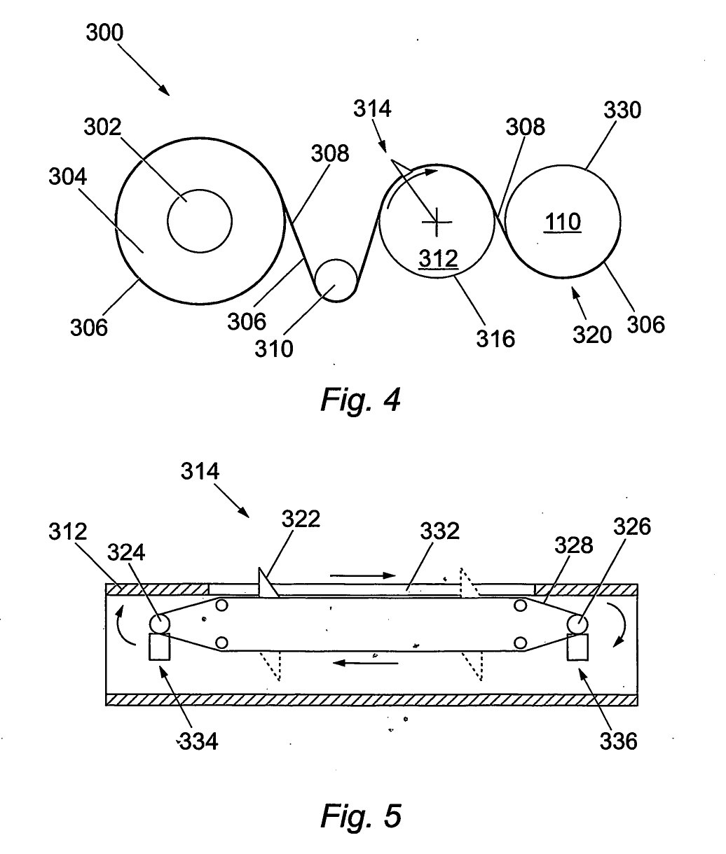

FIG. 4 is a schematic view of apparatus for sheeting a roll made in accordance with the present invention;

FIG. 5 is a side sectional view of a cutting roller of part of the apparatus of FIG. 4;

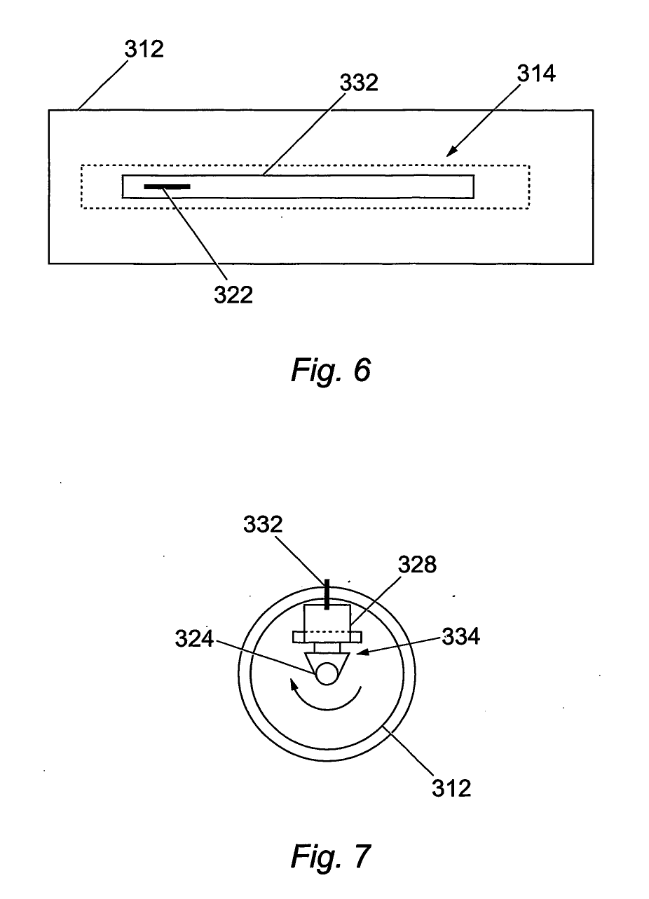

FIG. 6 is a top view of cutting roller of the apparatus of FIG. 5;

FIG. 7 is an end view of cutting roller; and

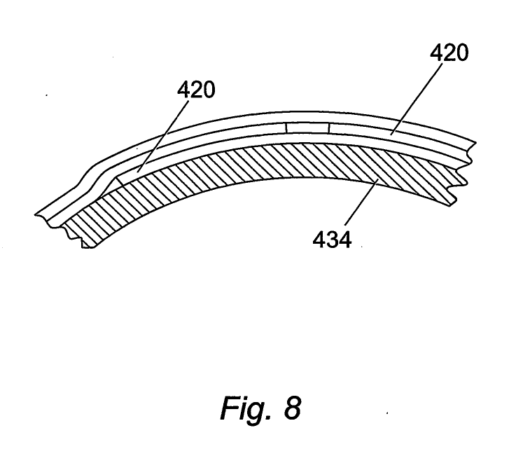

FIG. 8 is a detail of a cleaning roll produced by the apparatus.

Referring to the drawings, conventional apparatus 10 for cleaning a workpiece 20 advantageously comprises at least one cleaning roll 16 having a cleaning surface 18, and a roll core 12 having a continuous length of adhesive material 14 with an adhesive surface.

The cleaning roll 16 is rotatably mountable adjacent to the workpiece 20 in such a way that allows the cleaning surface 18 to be in contact at a point on a surface of the workpiece 20. Hence, as the workpiece 20 is conveyed, the cleaning roll 16 rotates and the cleaning surface 18 of the cleaning roll 16 removes any impurities located on the workpiece 20.

The cleaning surface 18 is typically elastomer coated or made of other forms of rubber or like material to facilitate the removal of impurities from the workpiece 20.

The roll core 12 is mountably rotatable adjacent the cleaning roll 16 relative to the workpiece 20. The roll core 12 and continuous adhesive material 14 is in contact at a point with the cleaning surface 18 of the cleaning roll 16.

The continuous adhesive material 14 facilitates the removal of impurities from the cleaning surface 18 of the cleaning roll 16 to the continuous adhesive material 14 by virtue of being in contact at a point on the cleaning surface 18.

The continuous adhesive material 14 is applied in this way, as opposed to being directly applied onto the conveyed workpiece 20, to avoid contaminating the workpiece 20 with adhesive from the continuous adhesive material 14.

When the continuous adhesive material 14 becomes contaminated, replacement is achieved by a user cutting away the contaminated portion of the continuous adhesive material 14, leaving behind a new clean portion of continuous adhesive material 14 for use.

A first embodiment of the present invention, as shown in FIG. 2, is in the form of a sheeted roll 100 which comprises a conventional roll core 110 with individual adhesive sheets 112, 114, 116 removably attachable around the circumference of the roll core 110 superimposed onto one another.

The roll core 110 has an attachment means which may be an adhesive coating to allow the first individual adhesive sheet 112 to be removably attachable around the circumference of the roll core 110.

The individual adhesive sheets 112, 114, 116 have an adhesive surface 118a-c facing outwardly, and have a non-adhesive surface facing inwardly, FIG. 2.

Alternatively the individual sheets can be rolled such that the adhesive surfaces are facing inwardly and the non-adhesive surfaces are facing outwardly.

The sheeted roll 100 is formed by attaching a first end 120 of the first sheet 112 onto the roll core 110 and wrapping the first sheet 112 around the circumference of the roll core 110.

The other end 122 of the first sheet 112 will overrun end 120 by virtue of the first sheet 112 being greater in length than the circumference of the roll core 110.

The end 122 is removably attached on end 120 by the adhesive surface 118a of the first sheet 112.

A second sheet 114 is then wrapped around the outer circumference of the first sheet 112 with end 124 of the second sheet 114 being abutted to end 122 of the first sheet 112. The term abutted is to be understood to include being adjacent to; there may be a gap between successive sheets.

The adhesive surface 118a of the first sheet 112 will securely hold in place the second sheet 114.

A third sheet 116 is then wrapped around the outer circumference of the second sheet 114 with end 128 of the third sheet 116 being abutted to end 126 of the second sheet 114.

The adhesive surface 118b of the second sheet 114 will securely hold in place the third sheet 116.

Similarly, further individual adhesive sheets (not shown) are abutted to end 130 of the third sheet 116 and so on until the roll core 110 is “full”.

It will be realised that because the sheets 112, 114, 116 are all of the same length, the overrun or circumferential offset of the respective ends 122, 126, 130, and so on, will decrease as the roll core 12 becomes “full”. The length of each sheet can however be adjusted as desired or required.

The offset of the abutment of the ends of the sheets disperses the load on the roll core 110 making the roll core 110 more stable when rotating.

In use, the roll core 110 is positioned such that the outermost sheet is positioned in contact at a point with the cleaning surface 18 of the conventional cleaning roll 16.

As both the roll core 110 and the cleaning roll 16 rotate, impurities located on the cleaning surface 18 will be transferred to the adhesive surface 118c of the outer sheet 116.

When the adhesive surface 118c of the outer sheet 116 becomes contaminated, replacement is simply achieved by peeling the contaminated sheet 116 away by virtue of lip 132, thus leaving behind a clean sheet 114 to be applied to the cleaning surface 18 of the cleaning roll 16, until that too needs replaced, and so on.

A second embodiment of the present invention in the form of a sheeted roll 200 comprises a conventional roll core 210 with individual adhesive sheets 212, 214, 216, 218, and so on, removably attachable around the circumference of the roll core 210 superimposed onto one another, FIG. 3.

In this second embodiment as opposed to the first embodiment, a first sheet 212 is attached to the roll core 210. The sheet 212 has an adhesive surface 212a which faces outwardly and has a non-adhesive surface which faces inwardly. The length of the first sheet 212 is equivalent to the circumference of the roll core such that the ends 220, 222 of which abut with one another. Abut should be understood to include the ends being adjacent to one another; there may be a gap between successive sheets.

A second sheet 214 is then removably attached to the first sheet 212, by virtue of the adhesive surface 212a of the first sheet 212. The length of this second sheet 214 is such that corresponding ends 224, 226 of the second sheet 214 abut with one another.

Similarly further sheets 216, 218, and so on, are removably attached to previous sheets 214, 216, 218, and so on. These further sheets 216, 218, and so on, are held securely in place by virtue of the adhesive surfaces 214a, 216a, 218a, and so on.

Points A, B, C, D indicate the position of abutment of the respective ends 220, 222, 224, 226, 228, 230, 232, 234. These points A, B, C, D are circumferentially spaced around the roll core 210 to facilitate replacement of the sheets 212, 214, 216, 218, and to maintain the structural integrity of the sheeted roll 200.

The length of each sheet can be adjusted as the roll becomes more “full” and the effective circumference becomes larger.

Whilst the present invention has been described in relation to an adhesive material, the present invention is also applicable to dry-film photopolymer laminate materials used particularly but not exclusively for imaging of circuit board materials, or any material having a sticky or tacky character.

An example of such laminates is a Mylar® backing film having an acrylic photosensitive emulsion.

Furthermore, it is to be realised that the present invention may be used for dispensing.

Referring now to FIGS. 4 to 7 of the drawings, the apparatus 300 for sheeting a roll according to the invention comprises a feed roller 302 provided with a continuous adhesive material 304, a guide roller 310 to transfer and guide the continuous adhesive material 304 onto surface 316 of a cutting roller 312, the cutting roller 312 provided with cutting means 314 to cut the continuous adhesive material 304 into individually cut sheets 320 which are then removably applied to a sheeting roller 110.

The feed roller 302 is provided with a continuous adhesive sheet 304 with an internal adhesive surface 118 and an external non-adhesive surface 308. The sheet may comprise polyester or paper coated with a pressure-sensitive adhesive.

The sheets can be rolled such that the adhesive layer is facing either inwardly or outwardly.

The feed roller 302 provided with the continuous adhesive material is typical of that known in the art.

The guide roller 310 guides and aligns the continuous adhesive material 304 on to surface 316 of the cutting roller 312.

The cutting roller 312 is hollow and has a non-stick surface 316 (formed of a material such as Teflon®) which allows the adhesive material 304 to be removably attached thereon, with the adhesive surface 118 facing inwardly towards the centre of the cutting roller 312, and the non-adhesive surface 308 facing outwardly, or vice versa.

The cutting means 314 comprises a blade 322 mounted on a drive belt 328, the drive belt 328 being conveyed between two co-planar rotating spindles 324, 326. The blade 322 protruding through a slot 332 in the cutting roller 312 to cut the adhesive material 304.

The rotating spindles 324, 326 are carried by supports 334, 336 which rotate with the rotating cutting roller 312 and thus ensures that the cutting means 314 moves at the same linear speed as the surface of the cutting roller 312.

The cutting means 314 is such that cutting of the adhesive material 304 will only occur along the slot 332.

A cut sheet is then fed to the sheeting roller 110 which is provided with an adhesive surface 330 to hold a first cut sheet 112 to the circumference of the sheeting roller 110, FIG. 2.

The cut sheets 112-116 (FIG. 2) produced by the cutting roller 312 will be substantially the same length dictated by the speed of rotation of the cutting roller 312 and the timing of the operation of the cutting means 314.

Therefore, in use, sheeting apparatus 300 forms a sheeted roll 100 in accordance with the following description.

The continuous adhesive material 304 located on the feed roller 302 is initially fed around the guide roller 310 and onto surface 316 of the cutting roller 312. The adhesive material 304 is removably attachable by virtue of the adhesive surface 306.

The sheeting apparatus 300 is then selectively operated to run for a duration which allows the cutting means 314 to cut a first cut sheet 112 which is then located onto the sheeting roller 110 to assist in forming a sheeted roll 100, FIG. 2.

End 120 of the first cut sheet 112 is attachable to a surface 330 of the sheeting roller 110, while the other end 122, is wrapped around the outer circumference of the sheeting roller 110 until end 122 overlaps with end 120.

The sheeting apparatus 300 once again is selectively operated to convey the adhesive material 304 past the cutting means 314.

As the adhesive material 304 passes by the slot 332, the blade 322 will protrude from the slot 332 and cut a second cut sheet 114.

The cut sheet 114 will then be conveyed onto the outer circumference of the sheeted roll 100 with end 124 of the second cut sheet 114 abutted with end 122 of the first cut sheet 112. The other end 126 of the second cut sheet 114 is wrapped around the outer circumference of the first cut sheet 112.

The adhesive material 304 is then cut again by the blade 322 of the cutting means 314 within the cutting roller 312 to cut a third cut sheet 116.

One end 128 of the third sheet 116 is abutted against end 126 of the second cut sheet 114. The third cut sheet 116 is then wrapped around the outer circumference of the second cut sheet 114.

Further cut sheets (not shown) are applied onto one another around the outer circumference of the sheeted roll 100 in the same way as described above until the sheeting roller 110 is “full”.

It will be recognised that as more and more cut sheets are located on sheeting roller 110, the amount of overlap or offset will decrease as the outer circumference of the sheeted roll 100 expands with the cut sheets located thereon. The offset in the abutment of the ends disperses the load on the sheeting roller 110 making the sheeted roll 100 more stable when rotating and maintains the structural integrity.

When “full”, the sheeting roller 110 is applied to apparatus 10 for cleaning a workpiece 18 as shown in FIG. 1.

The sheeting apparatus 300 can either be located remote or adjacent to the cleaning apparatus 10. If located adjacent then it will be recognised that the sheeting roller 316 may be adapted to be removably attachable and selectively operable between the cleaning apparatus 10 and the sheeting apparatus 300.

It will be recognised that the overlap forms a lip 132 which facilitates simple replacement of contaminated cut sheets.

It will be understood however that the thickness of the sheets 420 is greatly exaggerated in FIG. 8, and the overlap does not cause any problems in practice.

Modifications and improvements may be made to the above without departing from the scope of the present invention. It is clear that the forgoing provides sheeted rolls with the adhesive facing inwardly or outwardly. Also, for example, the sheeted roll may have a roll core with individual sheets of any length removably attachable onto the roll core. Also, the cutting means instead of being positioned within a cutting roller may be located proximate to the cutting roller. Furthermore, the individually cut sheets need not be located onto a sheeting roller. Instead, the cut sheets may be overlaid onto one another into a container.

What is claimed is:

1. A sheeted roll comprising a roll core having at least one sheet of material removably attachable thereon and subsequent sheets of material then being removably attachable on previous sheets of material on the roll core, said at least one sheet and subsequent sheets of material providing an adhesive surface holding the sheets to one another on said roll core.

2. The sheeted roll of claim 1, wherein the material includes an adhesive surface and the adhesive surface of each sheet faces either inwardly or outwardly.

3. The sheeted roll of claim 1, wherein each sheet is greater in length than the circumference of the roll core.

4. The sheeted roll of claim 1, wherein one end of each sheet is abutted to an end of another sheet.

5. The sheeted roll of claim 1, wherein the end of each sheet is abutted to the other end of said sheet.

6. The sheeted roll of claim 4, wherein the position of abutment of the sheets are circumferentially spaced around the roll core to maintain the structural integrity of the sheeted roll.

7. The sheeted roll of claim 1, wherein the adhesive is a pressure sensitive adhesive.

8. The sheeted roll of claim 1, wherein the sheets are adapted to be dispensed.

9. The sheeted roll of claim 1, wherein the material is a dry-film photopolymer laminate.

10. The sheeted roll of claim 9, wherein the laminate is a Mylar® backing film having an acrylic photosentive emulsion.

11. An apparatus for cleaning a workpiece comprising a sheeted roll according to claim 1 and at least one cleaning roll having a cleaning surface, the cleaning roll being rotatably mountable adjacent to a workpiece, the sheeted roll being rotatably mounted adjacent the cleaning roll relative to the workpiece.

12. Apparatus as claimed in claim 11 wherein the workpiece is an electronic circuit board.

13. An apparatus for sheeting a roll, said roll comprising a roll core having at least one sheet of material removably attachable thereon and subsequent sheets of material then being removably attachable on previous sheets of material on the roll core, said at least one sheet and subsequent sheets of material providing an adhesive surface holding the sheets to one another on said roll core, said apparatus comprising means for feeding material to be cut and a cutting roller having cutting means, the material being cut by said cutting means located within the cutting roller to form individually cut sheets.

14. The apparatus of claim 13, wherein the cutting means is rotatably coupled to the cutting roller.

15. The apparatus of claim 13, wherein the cut sheets are applied to a sheeting roller.

16. (canceled)

17. (canceled)
